(19) United States
(12) Patent Application Publication
(10) Pub. No.: US 2021/0251846 A1
(43) Pub. Date: Aug. 19, 2021

(54) BLOOD FLOW IMPROVEMENT DEVICE, CHAIR, BED

(71) Applicant: National University Corporation Tokai National Higher Education and Research System, Nagoya-shi Aichi (JP)

(72) Inventors: Masashi KATO, Nagoya-shi Aichi (JP); Nobutaka OHGAMI, Nagoya-shi Aichi (JP)

(21) Appl. No.: 17/273,560

(22) PCT Filed: Nov. 1, 2019
(86) PCT No.: PCT/JP2019/043072

§ 371 Date: Mar. 4, 2021

(30) Foreign Application Priority Data
Dec. 21, 2018 (JP) 2018-239849

(51) Int. Cl. A61H 23/02

(52) U.S. Cl. CPC A61H 23/0236; A61H 2209/00; A61H 2201/5005; A61H 2203/0443; A61H 2201/5007; A61H 2203/0431

(57) ABSTRACT

A setting unit sets a sound stimulus for improving blood flow. A sound generator generates the set sound stimulus. The setting unit sets a sound stimulus of a sound volume level of 65 decibels or more and a frequency of a value from 5 to 250 hertz. The sound generator may generate a sound stimulus of a continuous sound or generate a sound stimulus in an intermittent pattern in which an output period of the sound stimulus and a non-output period of the sound stimulus are alternately repeated. The setting unit may determine the sound volume level generated from the sound generator according to the distance to a subject.

### CROSS-REFERENCE TO RELATED APPLICATIONS

This application is based upon and claims the benefit of priority from Japanese Patent Application No. 2018-239849 filed on Dec. 21, 2018, the entire contents of which is incorporated herein by reference.

### TECHNICAL FIELD

The present disclosure relates to a technology for improving blood flow by utilizing sound stimuli.

### BACKGROUND ART

Decreased blood flow in the skin induces symptoms such as excessive sensitivity to cold, chilblains, and stiff shoulders. Low-frequency therapeutic devices are devices that improve blood flow by attaching electrode pads to the skin and directly stimulating the skin. However, it is necessary to pay attention to various matters at the time of use, such as not touching the electrode surface when the power is on.

### DISCLOSURE OF INVENTION

### Technical Problem

The present discloser paid attention to the biological effect of sound stimuli, found out that sound stimuli affect blood flow by conducting an experiment on the correlation between sound stimuli and blood flow, and found sound stimuli suitable for improving blood flow.

In this background, a purpose of the present disclosure is to provide a technology for improving blood flow by sound stimuli.

### Means for Solving the Problem

A blood flow improvement device according to one embodiment of the present invention includes: a setting unit that sets a sound stimulus for improving blood flow; and a sound generator that generates the set sound stimulus. The setting unit sets a sound stimulus of a sound volume level of 65 decibels or more and a frequency of a value from 5 to 250 hertz. The sound volume level that is set means a sound volume level when the sound stimulus generated by the sound generator is output and reaches a subject, that is, a sound volume level at the position of the subject.

A blood flow improvement device according to another aspect of the present disclosure includes: a setting unit that sets a sound stimulus for activating a mechanoreceptor; and a sound generator that generates the set sound stimulus. The setting unit sets a sound stimulus of a sound volume level of 65 decibels or more and a frequency of a value from 5 to 250 hertz. The sound volume level means a sound volume level when the sound stimulus generated by the sound generator is output and reaches a subject, that is, a sound volume level at the position of the subject.

Optional combinations of the aforementioned constituting elements and implementations of the present disclosure in the form of methods, apparatuses, systems, recording mediums, and computer programs may also be practiced as additional modes of the present disclosure.

### BRIEF DESCRIPTION OF DRAWINGS

FIG. 1 is a diagram showing the configuration of a blood flow improvement device according to an embodiment;

FIGS. 2A-2D are diagrams showing experimental results of measuring the blood flow rate of a mouse;

FIGS. 3A-3D are diagrams showing experimental results of measuring the blood flow rate of a mouse;

FIG. 4 is a diagram showing the rate of increased blood flow in a mouse;

FIG. 5 is a diagram showing the rate of increased blood flow in a mouse;

FIG. 6 is a diagram showing the rate of increased blood flow in a mouse;

FIG. 7 is a diagram showing the rate of increased blood flow in a person;

FIG. 8 is a diagram showing image examples of blood flow in mouse skin;

FIG. 9 is a diagram showing experimental result of measuring the blood flow rate in human skin;

FIGS. 10A-10B are diagrams showing experimental results of measuring the blood flow rate in human skin;

FIG. 11 is a diagram showing experimental result of investigating the influence of the frequency of a sound stimulus;

FIG. 12 is a diagram showing experimental result of investigating the influence of the frequency of a sound stimulus;

FIG. 13 is a diagram showing the rate of increased blood flow in human skin;

FIG. 14 is a diagram showing image examples of blood flow in a human hand;

FIG. 15 is a diagram showing experimental results of measuring blood flow rates in different tissues;

FIGS. 16A-16D are diagrams showing experimental results of measuring cerebral blood flow rate in a mouse:

FIGS. 17A-17B are diagrams showing experimental results of observing calcium uptake;

FIGS. 18A-18B are diagrams showing experimental results of observing calcium uptake;

FIG. 19 is a diagram schematically showing how calcium ions flow into vascular endothelial cells;

FIGS. 20A-20C are diagrams showing experimental results for verifying the involvement of endothelin receptor type B;

FIGS. 21A-21B are diagrams showing experimental results for verifying the involvement of nitric oxide;

FIGS. 22A-22B are diagrams showing the results of measuring the change in mouse body surface temperature caused by a sound stimulus;

FIG. 23 is a diagram showing the result of measuring the change in blood flow and skin surface temperature of a human finger;

FIG. 24 is a diagram showing images of a human finger captured by a thermography camera;

FIG. 25 is a diagram showing the result of observing the effect of a sound stimulus on the body weight of a mouse;

FIG. 26 is a diagram showing the change in mouse adipose tissue volume before and after the application of a sound stimulus;

FIG. 27 is a diagram showing the respiratory quotient of a mouse in the presence or absence of a sound stimulus;

FIG. 28 is a diagram showing the measurement results of items related to lifestyle-related diseases;

FIG. 29 is a diagram showing the result of observing the effect of improving blood flow in a model mouse for pressure ulcer by a sound stimulus;

FIG. 30 is a diagram showing the results of observing the effect of improving blood flow in a model mouse for pressure ulcer after a sound stimulus;

FIGS. 31A-31B are diagrams showing the results of observing the effect of improving a mouse pressure ulcer by a sound stimulus;

FIGS. 32A-32B are diagrams showing experimental results of measuring cerebral blood flow rate in a low cerebral blood flow model mouse:

FIGS. 33A-33B are diagrams showing the result of observing a ligated lower leg of a mouse;

FIGS. 34A-34B are diagrams showing an observation experiment of a fatigue recovery effect caused by a sound stimulus; and

FIG. 35 is a diagram showing another configuration of a blood flow improvement device according to the embodiment.

### DESCRIPTION OF EMBODIMENTS

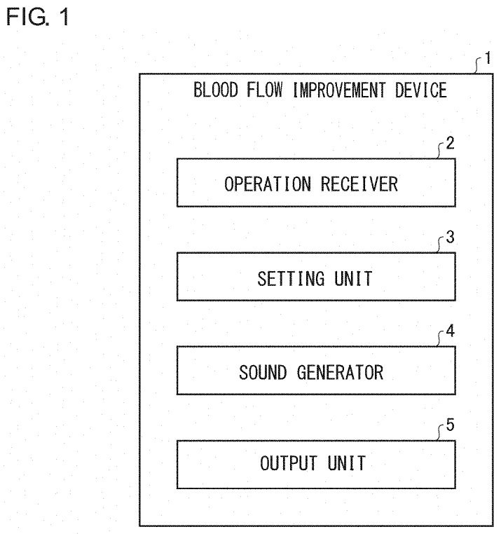

FIG. 1 shows the configuration of a blood flow improvement device 1 according to an embodiment. The blood flow improvement device 1 has a function of generating sound in a pattern of a sound stimulus that improves human blood flow, that is, improves human blood flow. Hereinafter, the sound generated by the blood flow improvement device 1 is also referred to as “sound stimulus”. The blood flow improvement device 1 includes an operation receiver 2 for receiving an operation for outputting a sound stimulus for improving blood flow, a setting unit 3 for setting a sound stimulus according to the operation, a sound generator 4 for generating a sound stimulus that has been set, and an output unit 5 for outputting the generated sound stimulus. The sound generator 4 according to the embodiment has a function of continuously or intermittently generating a pure sound having a set frequency. The output unit 5 is a speaker and may output sound from the blood flow improvement device 1 to the outside. Alternatively, the output unit 5 may output a sound signal to a speaker connected to the blood flow improvement device 1.

In FIG. 1, the elements shown in functional blocks that indicate a variety of processes are implemented in hardware by any circuit block, memory, or other LSI's, and in software by a program loaded in memory, etc. Therefore, a person skilled in the art should appreciate that there are many ways of accomplishing these functional blocks in various forms in accordance with the components of hardware only, software only, or the combination of both, and the way of accomplishing these functions is not limited to any particular one.

As will be described in detail later, the blood flow improvement device 1 according to the embodiment generates a sound stimulus having a volume level of 65 decibels (dB) or more and a frequency of a value from 5 to 250 hertz (HZ) for improving blood flow. The sound stimulus may be a continuous sound emitted continuously in time, or may be a discontinuous sound emitted intermittently and periodically. The blood flow improvement device 1 is installed as a medical device in a medical facility such as a hospital and is used for improving symptoms of patients with excessive sensitivity to cold, chloasma (spots), pressure ulcers (bedsores), or stiff shoulders. The doctor may be able to set the sound volume level and frequency depending on the severity of the symptom of the patient.

The blood flow improvement device 1 may be marketed as a healthcare device and used for the purpose of improving blood flow in a healthy person. The blood flow improvement device 1 is preferably formed in a compact manner so as to be able to be carried around. By distributing the blood flow improvement device 1 as a healthcare device, recovery from fatigue and prevention or improvement of lifestyle-related diseases, prevention or improvement of vascular obstructive diseases including economy class syndrome and gangrene of the arms and legs of diabetic patients, and beauty effects including weight loss can be expected by improving blood flow.

The present discloser has found through experiments and the like described below that a sound having a sound volume level of 65 dB or more and a frequency of a value from 5 to 250 Hz is a sound stimulus suitable for improving blood flow. The results of blood flow measurement when the sound volume level is changed are shown in some figures below. It should be noted that the sound volume level is the sound volume level at a blood flow measurement part of a mouse or a subject.

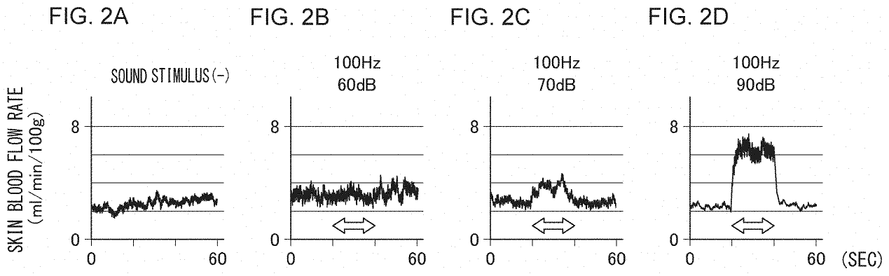

FIGS. 2A-2D show the experimental results of measuring the blood flow rate of a mouse while changing the sound volume level of a sound stimulus. In graphs shown in FIGS. 2A to 2D, the horizontal axis represents time (seconds), and the vertical axis represents skin blood volume (ml/min/100 g). The sound stimulus was a discontinuous sound in which an output period of 100 ms and a non-output period of 600 ms were alternately repeated, and a laser Doppler blood flowmeter was used to measure the blood flow rate. The sound volume levels shown in FIGS. 2B to 2D are sound volume levels at a blood flow measurement part of a mouse, and double-headed arrows indicate periods during which the sound stimulus was applied.

FIG. 2A shows the change in the skin blood flow rate when no sound stimulus was applied. When no sound stimulus was applied, the skin blood flow rate did not change. FIG. 2B shows the change in the skin blood flow rate when a sound stimulus having a sound volume level of 60 dB and a frequency of 100 Hz was applied. In FIG. 2B, the skin blood flow rate did not change during the application period of the sound stimulus. Therefore, the sound stimulus of a sound volume level of 60 dB and a frequency of 100 Hz did not improve the skin blood flow. FIG. 2C shows the change in the skin blood flow rate when a sound stimulus having a sound volume level of 70 dB and a frequency of 100 Hz was applied. In FIG. 2C, the skin blood flow rate increased during the application period of the sound stimulus. Therefore, the sound stimulus of a sound volume level of 70 dB and a frequency of 100 Hz improves the skin blood flow. FIG. 2D shows the change in the skin blood flow rate when a sound stimulus having a sound volume level of 90 dB and a frequency of 100 Hz was applied. In FIG. 2D, the skin blood flow rate increased significantly during the application period of the sound stimulus. Therefore, a sound stimulus of a sound volume level of 90 dB and a frequency of 100 Hz significantly improves the skin blood flow. The experimental results shown in FIG. 2 show that the skin blood flow is improved by a sound stimulus of 70 dB or more at 100 Hz.

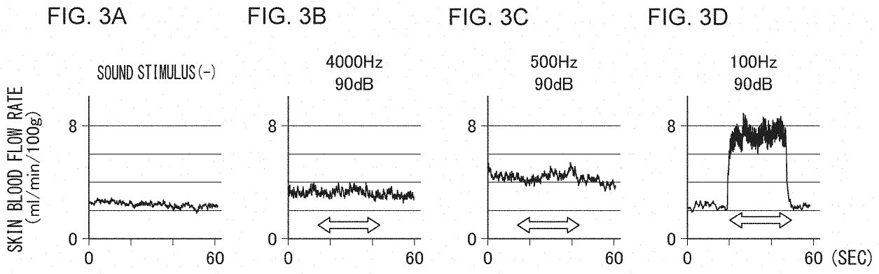

FIGS. 3A-3D show the experimental results of measuring the blood flow rate of a mouse while changing the frequency of a sound stimulus. In graphs shown in FIGS. 3A to 3D, the horizontal axis represents time (seconds), and the vertical axis represents skin blood volume (ml/min/100 g). Based on the experimental results shown in FIG. 2, it was shown that a sound stimulus of 90 dB greatly improved skin blood flow. Therefore, in the experimental results shown in FIGS. 3B to 3D, the respective sound volume levels of sound stimuli at the mouse position were all set to 90 dB. In the same way as in the experiments shown in FIG. 2, the sound stimulus was a discontinuous sound in which an output period of 100 ms and a non-output period of 600 ms were alternately repeated. In graphs of FIGS. 3B to 3D, double-headed arrows indicate periods during which the sound stimulus was applied.

FIG. 3A shows the change in the skin blood flow rate when no sound stimulus was applied. When no sound stimulus was applied, the skin blood flow rate did not change. FIG. 3B shows the change in the skin blood flow rate when a sound stimulus having a sound volume level of 90 dB and a frequency of 4000 Hz was applied. In FIG. 3B, the skin blood flow rate did not change during the application period of the sound stimulus. Therefore, the sound stimulus of a sound volume level of 90 dB and a frequency of 4000 Hz does not improve the skin blood flow. FIG. 3C shows the change in the skin blood flow rate when a sound stimulus having a sound volume level of 90 dB and a frequency of 500 Hz was applied. In FIG. 3C, the skin blood flow rate did not change during the application period of the sound stimulus. Therefore, the sound stimulus of a sound volume level of 90 dB and a frequency of 500 Hz does not improve the skin blood flow. FIG. 3D shows the change in the skin blood flow rate when a sound stimulus having a sound volume level of 90 dB and a frequency of 100 Hz was applied. As shown in FIG. 2D, the skin blood flow rate increased significantly during the application period of the sound stimulus. The experimental results shown in FIGS. 3A-3D show that the skin blood flow is not improved by a sound stimulus at sound intensity of 90 dB with frequencies of higher than 500 Hz.

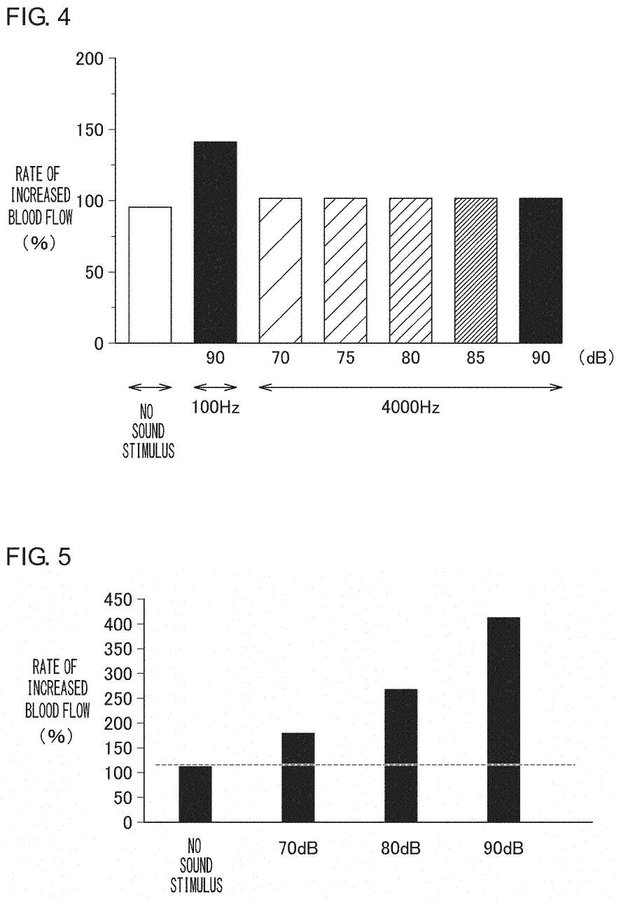

FIG. 4 shows the rate of increased blood flow in a mouse measured under various conditions. The rate of increased blood flow (%) is calculated by:

(blood flow rate when a sound stimulus is applied/blood flow rate when no sound stimulus is applied)×100

According to the rate of increased blood flow shown in FIG. 4, it is shown that although a sound stimulus of 100 Hz improves the blood flow, a sound stimulus of 4000 Hz does not improve the blood flow even if the sound volume level is changed.

FIG. 5 shows the rate of increased blood flow when the blood flow rate of a mouse was measured while changing the sound volume level of a sound stimulus. The sound stimulus was a discontinuous sound in which an output period of 100 ms and a non-output period of 600 ms were alternately repeated, and the frequency of the sound stimulus was set to 100 Hz.

The experimental result shown in FIG. 5 shows that skin blood flow is improved by a sound stimulus of 70 dB or more. Taking into account the experimental results shown in FIG. 2, it is found that skin blood flow is not improved by a sound stimulus of 60 dB or less but is improved by a sound stimulus of 70 dB or more.

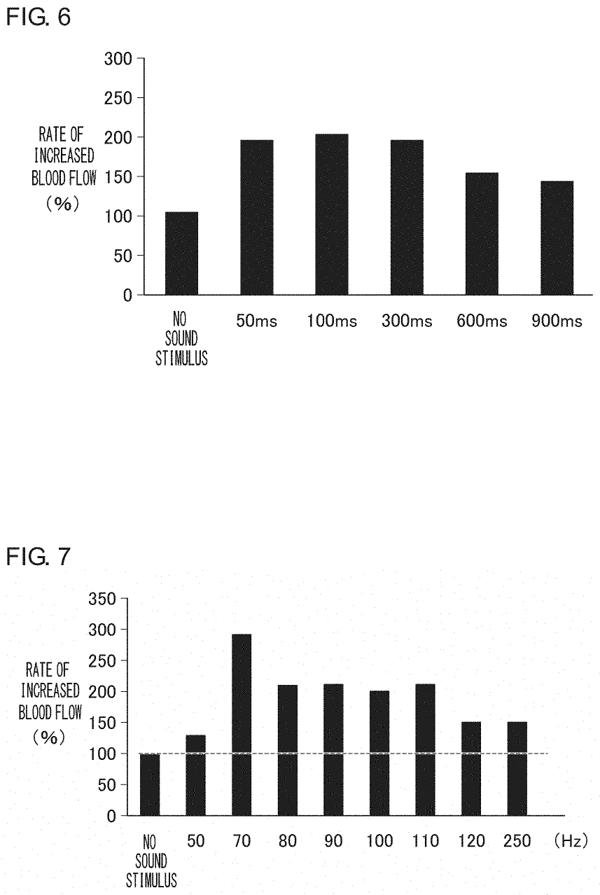

FIG. 6 shows the rate of increased blood flow when the blood flow rate of a mouse was measured while changing the pattern of the discontinuous sound. The pattern of the discontinuous sound is an intermittent pattern in which an output period and a non-output period are alternately repeated. In FIG. 6, the output period is fixed at 100 ms, and the non-output period is changed to 50 ms, 100 ms, 300 ms, 600 ms, and 900 ms. Based on this experimental result, it is shown that the rate of increased blood flow is the highest when the output period and the non-output period are each set to 100 ms.

FIG. 7 shows the rate of increased blood flow when the blood flow rate in a person was measured while changing the frequency. The sound stimulus was a discontinuous sound in which an output period of 100 ms and a non-output period of 100 ms were alternately repeated, and the sound volume level of the sound stimulus at the position of the person was set to 80 dB. In the embodiment, the sound volume level means the sound volume level when sound output from the blood flow improvement device 1 reaches a person.

According to this experimental result, the sound stimulus from 50 Hz to 250 Hz showed a significant rate of increased blood flow, and in this range, the sound stimulus from 70 Hz to 250 Hz showed a more significant rate of increased blood flow. Further, a sound stimulus from 70 Hz to 110 Hz showed a large rate of increased blood flow. Taking into account the experimental results shown in FIG. 3, it is found that skin blood flow is not improved by a sound stimulus of a frequency of 500 Hz or more but is improved by a sound stimulus of a frequency of a value from at least 50 to 250 Hz.

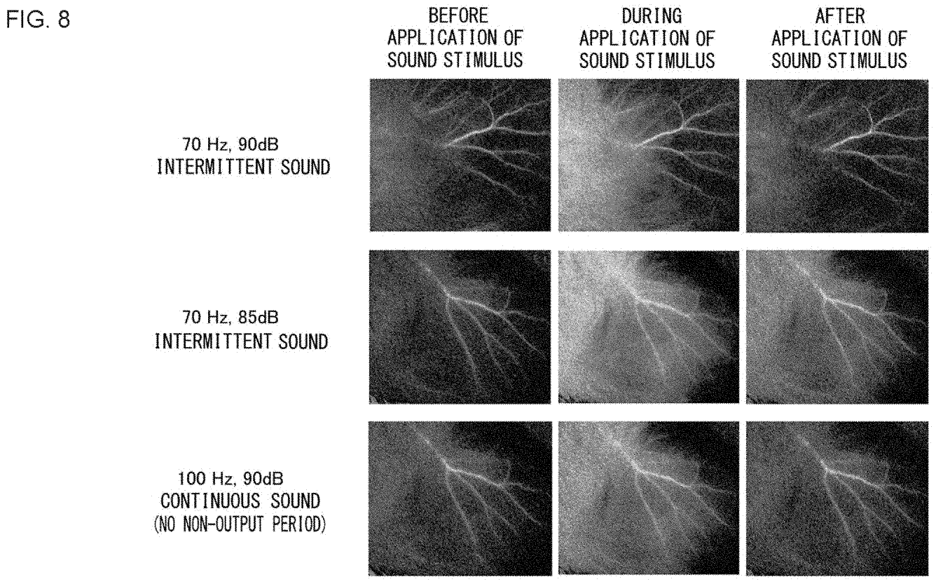

FIG. 8 shows image examples in which the blood flow of mouse skin is visualized by imaging technology. In the images, bright parts indicate blood flow. Comparing images before and during the application of a sound stimulus, it is shown that the blood flow increased during the application of the sound stimulus of an intermittent sound and the sound stimulus of a continuous sound.

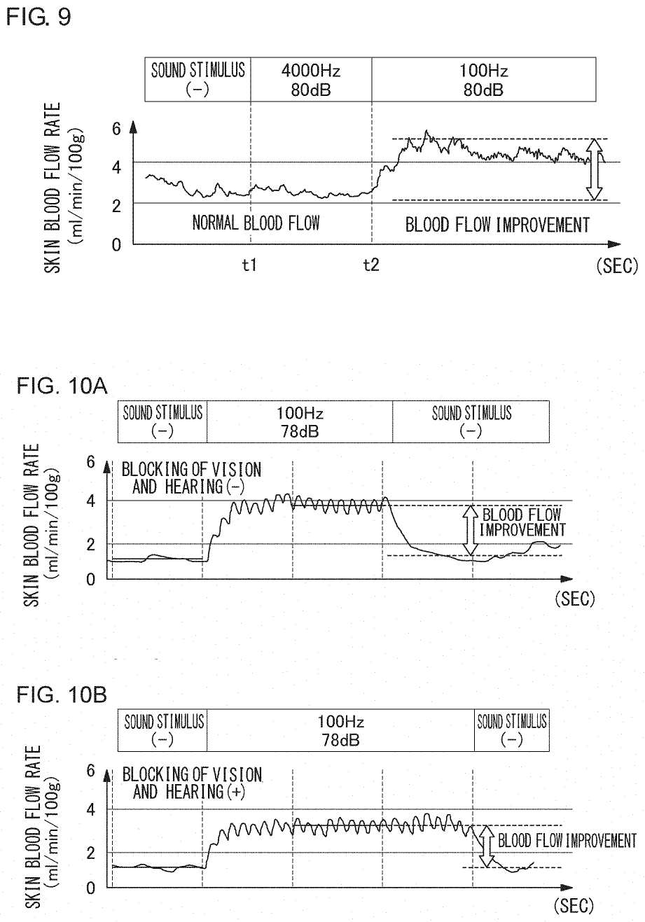

FIG. 9 shows the experimental result of measuring the blood flow rate in human skin by temporally changing the frequency of the sound stimulus. The measurement of skin blood flow rate was started from a state where no sound stimulus was applied, and a sound stimulus of 80 dB and 4000 Hz was applied to the subject from time t1 to t2. However, the blood flow rate did not change. When the frequency was changed to 100 Hz at the time t2, an increased blood flow rate was measured. This experiment showed that a sound stimulus of 4000 Hz does not affect human skin blood flow but a sound stimulus of 100 Hz improves human skin blood flow.

Next, a comparative experiment was conducted to confirm that the promotion of skin blood flow shown in FIG. 9 was not caused by the influence of human vision or hearing. FIG. 10A shows the experimental result of measuring the skin blood flow rate in a state where the subject's vision and hearing were not blocked, and FIG. 10B shows the experimental result of measuring the skin blood flow rate in a state where the subject's vision and hearing were blocked. An eye mask and earmuffs were used to block the vision and hearing. Based on this comparative experiment, it was confirmed that the change in blood flow were not due to the influence of vision or hearing. When the blood flow of a hand was measured while the hand was wearing a glove, it was also confirmed that the blood flow was improved by the sound stimulus.

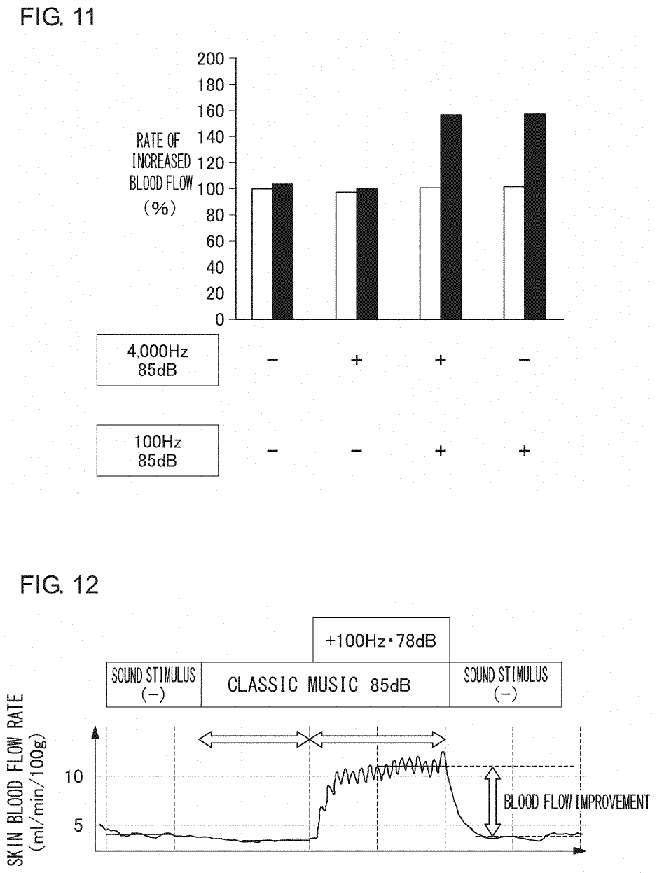

FIG. 11 shows experimental results of investigating the influence of the frequency of a sound stimulus on a mouse. In FIG. 11, white bar graphs show rates of increased blood flow obtained when no sound stimulus was applied, and black bar graphs show rates of increased blood flow obtained when a sound stimulus was applied.

The black bar graph on the far left shows the rate of increased blood flow in the absence of sound stimuli. Therefore, the rate of increased blood flow is approximately 100%. The second black bar graph from the left shows the rate of increased blood flow when a sound stimulus of 4000 Hz and 85 dB was applied. The blood flow did not change even when a sound stimulus of 4000 Hz was applied. The third black bar graph from the left shows the rate of increased blood flow when a sound stimulus of 4000 Hz and 85 dB and a sound stimulus of 100 Hz and 85 dB were applied at the same time. At this time, the promotion of blood flow was detected. The fourth black bar graph from the left shows the rate of increased blood flow when a sound stimulus of 100 Hz and 85 dB was applied. At this time, the promotion of blood flow was detected. Based on the experimental results shown in FIG. 11, it was shown that the blood flow is improved by a sound stimulus of 100 Hz and that the promotion of the blood flow by a sound stimulus of 100 Hz is not affected by a sound stimulus of 4000 Hz.

FIG. 12 shows experimental result of investigating the influence of the frequency of a sound stimulus in a human skin. In this experiment, the skin blood flow rate was measured while applying a sound stimulus of 100 Hz and 78 dB to the subject in an environment where classical music was exposed at 85 dB. The blood flow did not change when there was no sound stimulus and when classical music was exposed to the subject. In this experiment, it was shown that the skin blood flow rate increased only during a period when a sound stimulus of 100 Hz and 78 dB was applied to the subject. That is, it was found that blood flow was able to be specifically improved by applying a person a sound stimulus of 100 Hz even under an environment with various sounds.

Therefore, the sound generator 4 of the blood flow improvement device 1 may include a function of superimposing a sound stimulus on sound being generated while generating sound such as music. For example, by superimposing a sound stimulus during the output of music, the user can effectively improve the blood flow while listening to music.

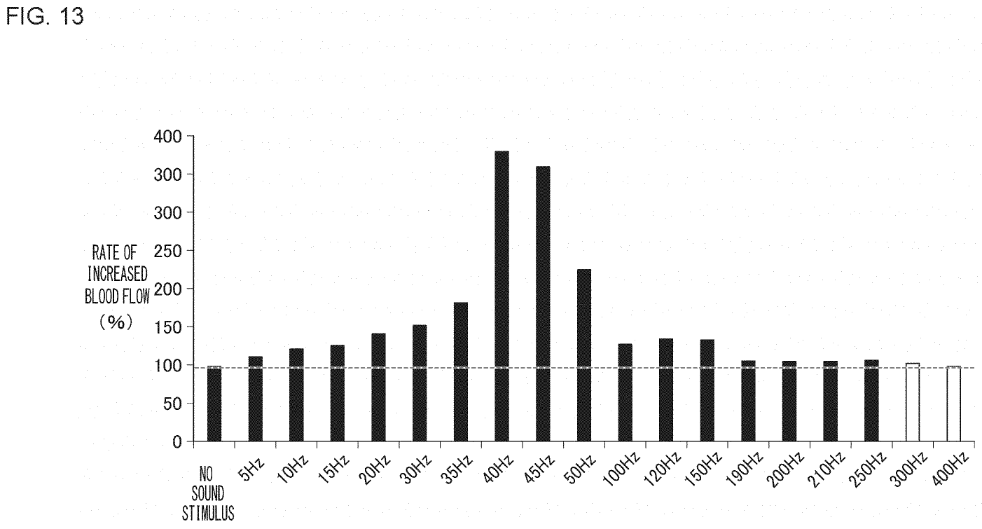

FIG. 13 shows the rate of increased blood flow when the blood flow rate in human skin was measured while changing the frequency. Sound stimuli applied to a person were continuous sounds that were continuously emitted without including a non-output period, and the respective sound volume levels of the sound stimuli at the position of the person were all set to 85 dB.

According to this experimental result, the sound stimulus from 5 Hz to 250 Hz showed a significant rate of increased blood flow, and in this range, the sound stimulus from 20 Hz to 150 Hz showed a more significant rate of increased blood flow. Further, a sound stimulus from 35 Hz to 50 Hz showed a large rate of increased blood flow. As described above, it was found that the skin blood flow is improved by a sound stimulus of a frequency of a value from 5 to 250 Hz.

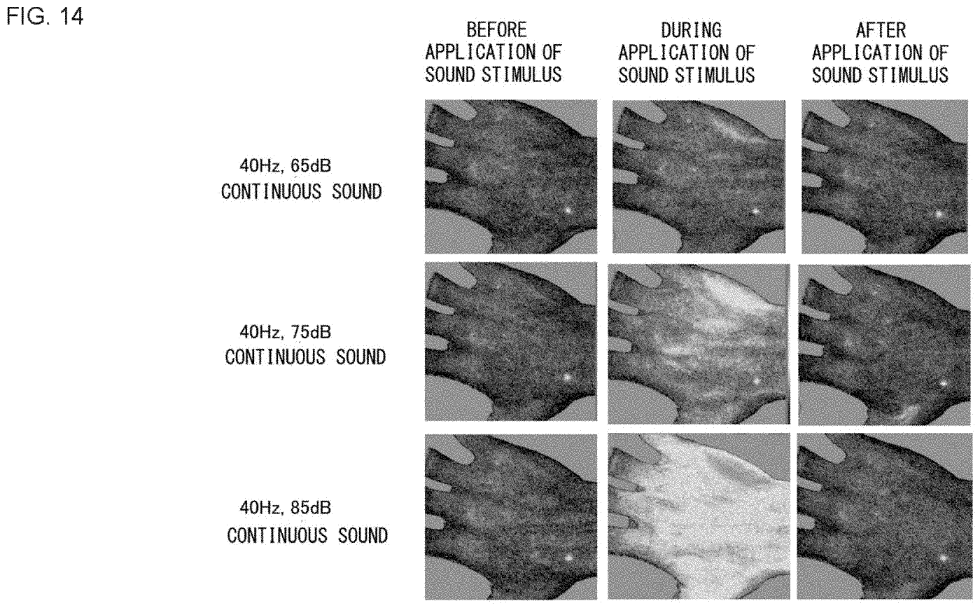

FIG. 14 shows image examples in which the blood flow of a human hand is visualized by imaging technology. The images were acquired by a laser Doppler blood flow imaging device. Since the experimental result shown in FIG. 13 showed that the sound stimulus of a continuous sound of 40 Hz greatly improved the skin blood flow, the respective frequencies were all set to 40 Hz and the respective sound volume levels were set to 65 dB, 75 dB, and 85 dB, respectively, so as to image the blood flow of the human hand.

In the blood flow images, bright areas indicate areas with a high blood flow rate. Comparing images before the application of sound stimuli, images during the application of the sound stimuli, and images after the application of the sound stimuli, it is shown that the blood flow increased during the application of the sound stimuli. Based on these images, it is confirmed that the blood flow increases when the sound volume level is set to 65 dB or more at the position of a part of a person.

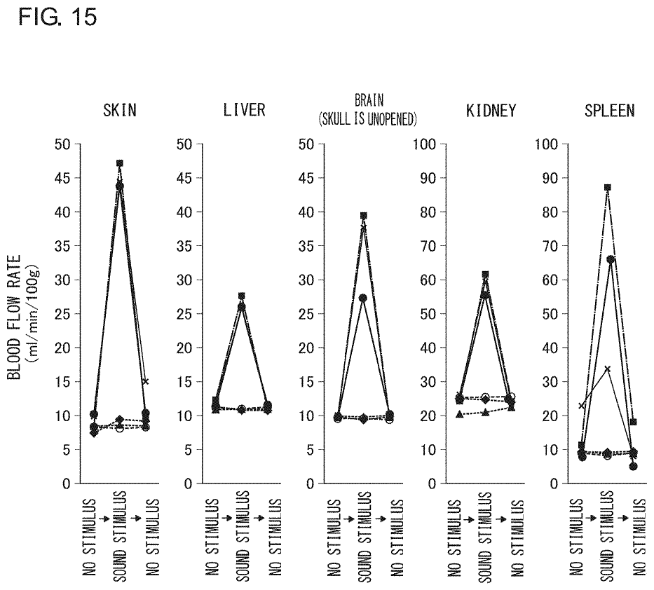

FIG. 15 shows the experimental results of measuring the blood flow rate in a plurality of tissues of a mouse. In FIG. 15, dotted lines show the change in the blood flow rate when no sound stimulus was applied, and solid lines show the change in the blood flow rate when a sound stimulus (100 Hz, 90 dB) was applied. The experimental results show that the blood flow is improved by applying a sound stimulus even in a part other than the skin.

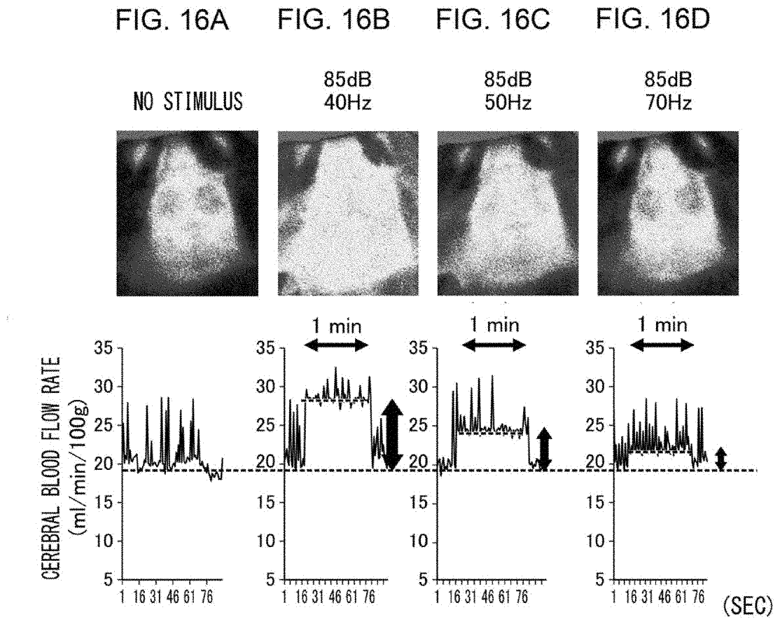

FIGS. 16A-16D show the experimental results of measuring the cerebral blood flow rate of a mouse while changing the frequency of a sound stimulus. In graphs shown in FIGS. 16A to 16D, the horizontal axis represents time (seconds), and the vertical axis represents cerebral blood volume (ml/min/100 g). In each of the experimental results shown in FIGS. 16B to 16D, the sound volume level of a sound stimulus in the head of the mouse was set to 85 dB, and the sound stimulus was a continuous sound. In the images, white parts indicate areas with high blood flow, and dark parts indicate areas with low blood flow. In graphs of FIGS. 16B to 16D, double-headed arrows indicate periods (one minute) during which the sound stimulus was applied.

FIG. 16A shows the change in the cerebral blood flow rate when no sound stimulus was applied. Without a sound stimulus that was applied, the steady level of the cerebral blood flow rate did not change. FIG. 16B shows the change in the cerebral blood flow rate when a sound stimulus having a sound volume level of 85 dB and a frequency of 40 Hz was applied. In FIG. 16B, the cerebral blood flow rate increased during the application period of the sound stimulus. Therefore, the sound stimulus of a sound volume level of 85 dB and a frequency of 40 Hz increases the cerebral blood flow rate. FIG. 16C shows the change in the cerebral blood flow rate when a sound stimulus having a sound volume level of 85 dB and a frequency of 50 Hz was applied. In FIG. 16C, the cerebral blood flow rate increased during the application period of the sound stimulus. Therefore, the sound stimulus of a sound volume level of 85 dB and a frequency of 50 Hz increases the cerebral blood flow rate. FIG. 16D shows the change in the cerebral blood flow rate when a sound stimulus having a sound volume level of 85 dB and a frequency of 70 Hz was applied. In FIG. 16D, the cerebral blood flow rate was increased during the application period of the sound stimulus. Therefore, the sound stimulus of a sound volume level of 85 dB and a frequency of 70 Hz increases the cerebral blood flow rate. The experimental results shown in FIGS. 16A-16D show that the cerebral blood flow is improved by a sound stimulus of a frequency in a range of at least from 40 Hz to 70 Hz at a sound volume level of 85 dB.

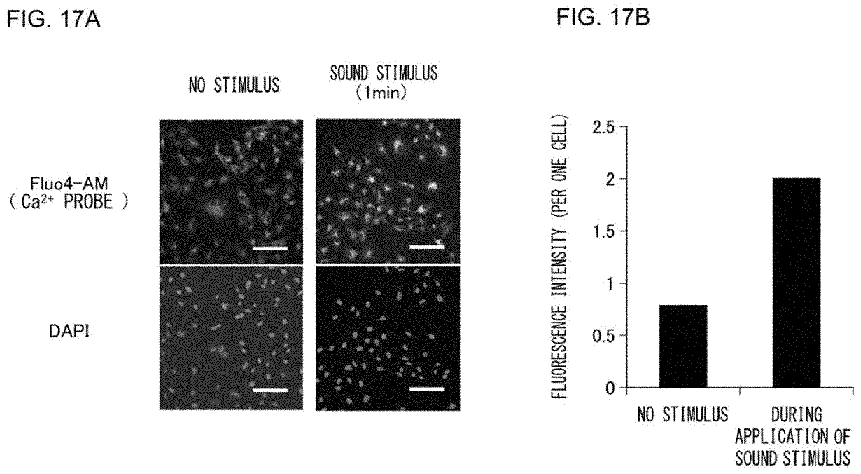

FIG. 17A shows images of calcium in the A549 cell line before and during the application of a sound stimulus obtained by imaging technology, and calcium is visualized by fluorescence. The sound stimulus was a discontinuous sound in which an output period of 100 ms and a non-output period of 100 ms were alternately repeated, and the frequency of the sound stimulus was 100 Hz and the sound volume level was 85 dB. FIG. 17B shows the fluorescent intensity before and during the application of the sound stimulus. It is shown that the sound stimulus increased calcium, i.e., blood flow.

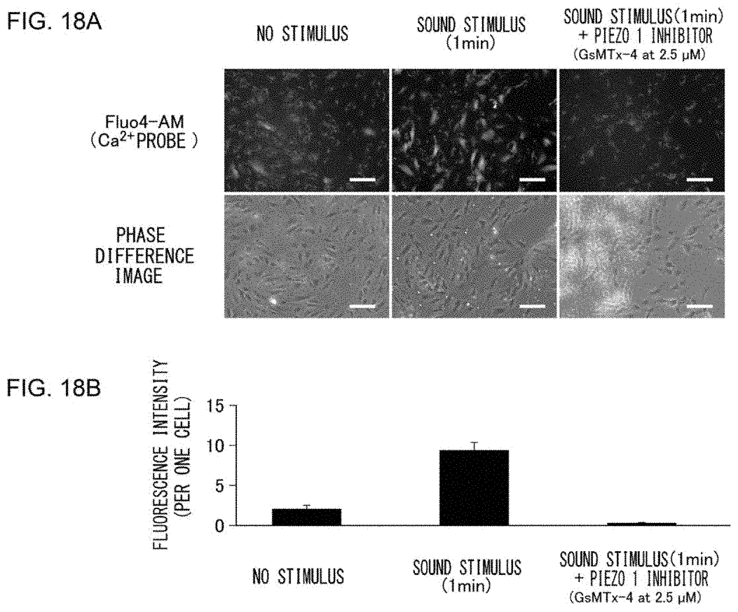

FIG. 18A shows images of calcium in human umbilical vein endothelial cells (HUVEC cells) obtained by imaging technology. The sound stimulus was a discontinuous sound in which an output period of 100 ms and a non-output period of 100 ms were alternately repeated, and the frequency of the sound stimulus was 70 Hz and the sound volume level was 85 dB. The left side shows an image before the application of the sound stimulus, the center shows an image during the application of the sound stimulus, and the right side shows an image during the application of the sound stimulus in a state where an inhibitor of ion channel piezo 1 was injected. FIG. 18B shows the fluorescence intensity before the application of the sound stimulus, during the application of the sound stimulus, and during the application of the sound stimulus in a state where an inhibitor of ion channel piezo 1 was injected. Comparing the left and center images, it is shown that the sound stimulus increased calcium, i.e., blood flow.

Piezo 1 is known as an ion channel activated by mechanical stimulation. According to the fluorescence images and the fluorescence intensity shown on the right side of FIGS. 18A and 18B, the amount of calcium uptake did not increase even if a sound stimulus was applied in the presence of the piezo 1 inhibitor. On the other hand, according to the fluorescence images and the fluorescence intensity shown in the center, in the absence of the piezo 1 inhibitor, the piezo 1 was activated by the sound stimulus, and the amount of calcium uptake was increased. Based on this, the present discloser has obtained knowledge that piezo 1 is activated not only by mechanical stimulation but also by sound stimulation.

The present discloser set a sound stimulus having a sound volume level of 65 dB or more and a frequency of a value from 5 to 250 Hz, and examined the amount of calcium uptake in HUVEC. It was observed that the fluorescence intensity increased compared to a case where there was no sound stimulus. That is, it was observed that the set sound stimulus activated the piezo 1 and increased the blood flow. Therefore, through this experiment, it was confirmed that the ion channel piezo 1 was able to be activated by the setting unit 3 setting a sound stimulus having a sound volume level of 65 dB or more and a frequency of a value from 5 to 250 Hz and the sound generator 4 generating the sound stimulus.

Based on the above knowledge, the present discloser considers that the mechanism for improving blood flow by an appropriate sound stimulus is based on the following steps 1 to 3. Here, based on the various above-mentioned experiments, the appropriate sound stimulus is a sound stimulus having a sound volume level of 65 dB or more and a frequency of a value from 5 to 250 Hz.

(Step 1)

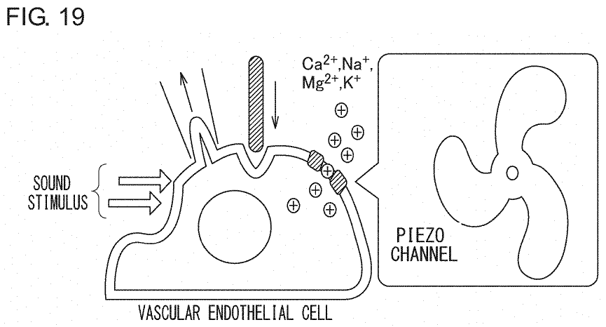

Mechanoreceptors (piezo 1, TRPV1) expressed on vascular endothelial cells are activated by applying an appropriate sound stimulus to a part of a person. FIG. 19 schematically shows how mechanoreceptor channels are opened and calcium ions flow into a vascular endothelial cell from the outside when a sound stimulus is applied to the vascular endothelial cell. It has been verified by the experimental results shown in FIGS. 18A and 18B that mechanoreceptor channels are opened by sound stimuli and calcium ions flow into vascular endothelial cells.

(Step 2)

An increased inflow of calcium ions activates endothelin receptors.

(Step 3)

The activation of the endothelin receptors causes nitrogen monoxide to be released and blood vessels to be dilated. It is known from past studies that when nitrogen monoxide is released, blood vessels are temporarily dilated, which increases peripheral blood flow.

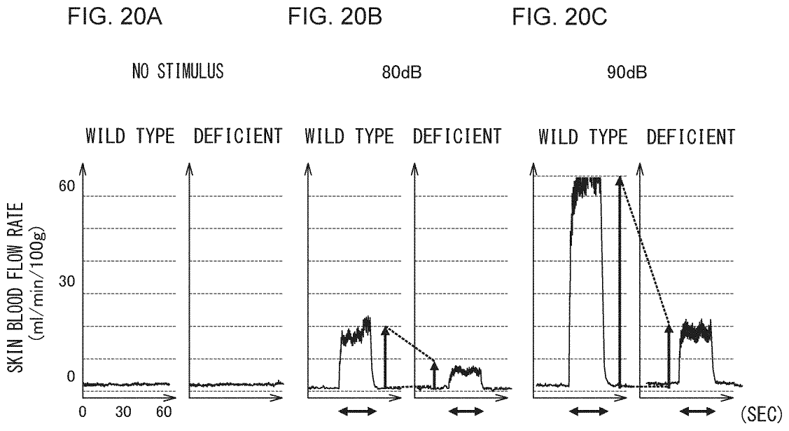

The experimental results for verifying Steps 2 and 3 are shown below. FIGS. 20A-20C show experimental results for verifying the influence of endothelin receptors. In each graph shown in FIGS. 20A to 20C, the horizontal axis represents time (seconds), and the vertical axis represents skin blood volume (ml/min/100 g). The graph on the left side shows the skin blood flow rate of a wild-type mouse, and the graph on the right side shows the skin blood flow rate of a mouse without endothelin receptors (hereinafter, referred to as “deficient mouse”). In FIGS. 20B to 20C, double-headed arrows indicate periods during which a sound stimulus, which was a continuous sound, was applied.

FIG. 20A shows the change in the skin blood flow rate when no sound stimulus was applied. When no sound stimulus was applied, the skin blood flow rate did not change in both wild-type and deficient mice. FIG. 20B shows the change in the skin blood flow rate when a sound stimulus having a sound volume level of 80 dB and a frequency of 40 Hz was applied. The skin blood flow rate of the wild-type mouse and the skin blood flow rate of the deficient mouse both increased. However, when the degree of increase was compared, while the skin blood flow rate of the wild-type mouse increased significantly, the degree of increase of the skin blood flow rate of the deficient mouse was small. FIG. 20C shows the change in the skin blood flow rate when a sound stimulus having a sound volume level of 90 dB and a frequency of 40 Hz was applied. As in the graph shown in FIG. 20B, the skin blood flow rate of the wild-type mouse and the skin blood flow rate of the deficient mouse both increased. However, when the degree of increase was compared, while the skin blood flow rate of the wild-type mouse increased significantly, the degree of increase of the skin blood flow rate of the deficient mouse was small.

According to the experimental results shown in FIGS. 20A-20C, it was found that the blood flow rate increased significantly when a sound stimulus was applied in the presence of the endothelin receptors while the amount of increased blood flow was suppressed even when a sound stimulus was applied in the absence of endothelin receptors. That is, it was verified that the activation of the endothelin receptors in Step 2 had a great influence on the increased blood flow rate.

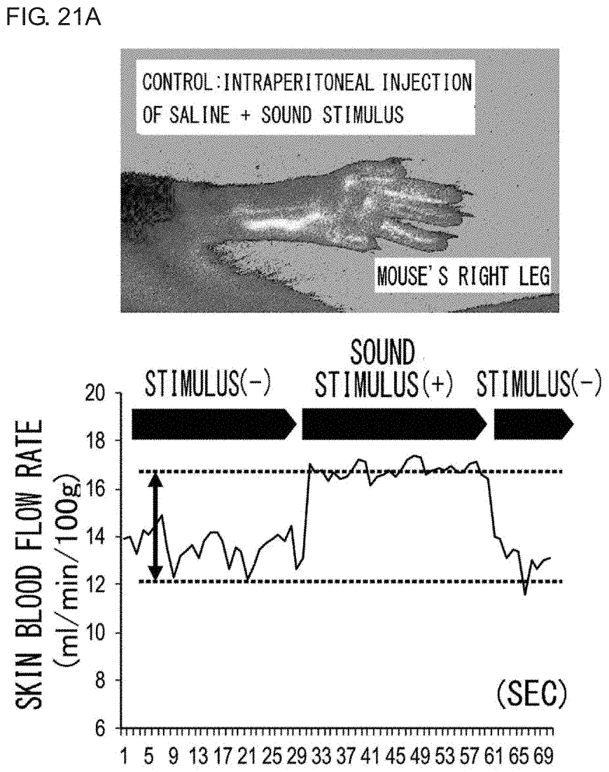

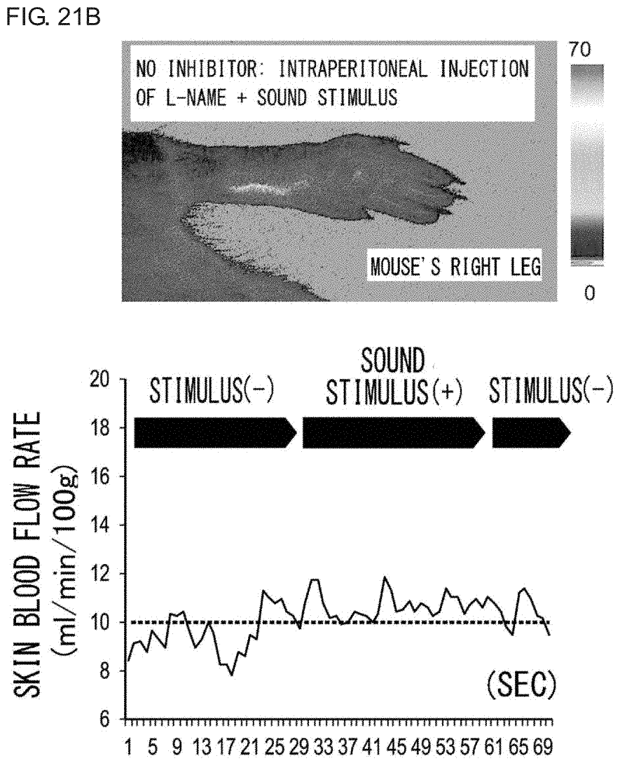

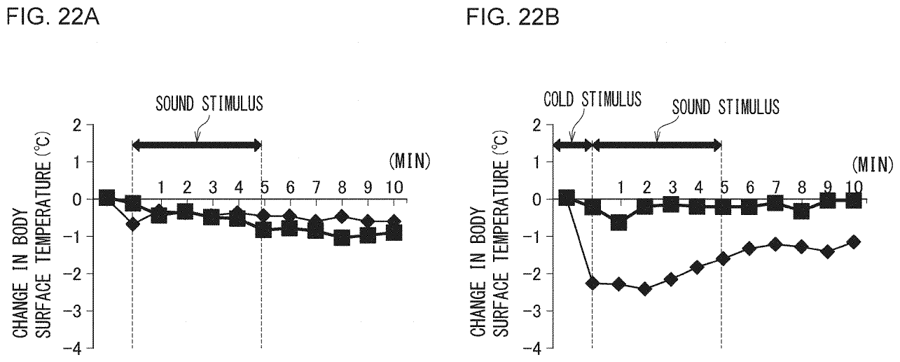

FIGS. 21A and 21B show experimental results for verifying the influence of nitrogen monoxides. In graphs shown in FIGS. 21A to 21B, the horizontal axis represents time (seconds), and the vertical axis represents skin blood volume (ml/min/100 g), and a sound stimulus, which was a continuous sound, was applied to the mouse.

FIG. 21A shows the change in the skin blood flow rate of a mouse undergone the intraperitoneal injection of saline, and FIG. 21B shows the change in the skin blood flow rate of a mouse undergone the intraperitoneal injection of nitrogen monoxide inhibitor L-NAME. The graph shown in FIG. 21A shows that the skin blood flow rate increased when a sound stimulus was applied. On the other hand, in the graph shown in FIG. 21B, the skin blood flow rate did not change in response to a sound stimulus. Based on this experiment, it was found that the blood flow rate did not increase when nitrogen monoxide release was inhibited. That is, it was verified that the release of the nitrogen monoxides in Step 3 had a great influence on the increased blood flow rate. Based on the above experiments, it was verified that an appropriate sound stimulus improved the blood flow by the mechanisms according to Steps 1 to 3.

FIGS. 22A and 22B show the results of measuring the change in mouse body surface temperature caused by a sound stimulus. The sound stimulus was a discontinuous sound, and the frequency of the sound stimulus was 100 Hz and the sound volume level was 85 dB. FIG. 22A shows the change in the body surface temperature at room temperature. A change curve connecting square plot points shows the change in the average body surface temperature of a plurality of mice when a sound stimulus was applied, and a change curve connecting diamond-shaped plot points shows the change in the average body surface temperature of a plurality of mice when no sound stimulus was applied. According to this graph, it is observed that the body surface temperature is substantially constant at room temperature regardless of the presence or absence of a sound stimulus.

FIG. 22B shows the change in the body surface temperature after a cold stimulus was applied. In this observation, the hind legs of mice were immersed in cold water (8.3 degrees Celsius) for five minutes, and the average values of the change in the body surface temperatures (hind leg surface temperatures) of the plurality of mice in the presence or absence of a subsequent sound stimulus were plotted. A change curve connecting square plot points shows the change in the average body surface temperature of the plurality of mice when a sound stimulus was applied to the hind legs pulled out from the cold water after the application of the cold stimulus, and a change curve connecting diamond-shaped plot points shows the change in the average body surface temperature of the plurality of mice when no sound stimulus was applied after pulling out the hind legs from the cold water after the application of the cold stimulus.

As shown in the change curve when the sound stimulus was applied in FIG. 22B, immediately after the sound stimulus was applied, the body surface temperatures of the hind legs of the mice returned to almost the respective body surface temperatures obtained before the application of the cold stimulus. In other words, it is confirmed that if a sound stimulus is applied when the body temperature is low, the body temperature returns to normal in a short time. This indicates that a sound stimulus is effective in recovering from excessive sensitivity to cold.

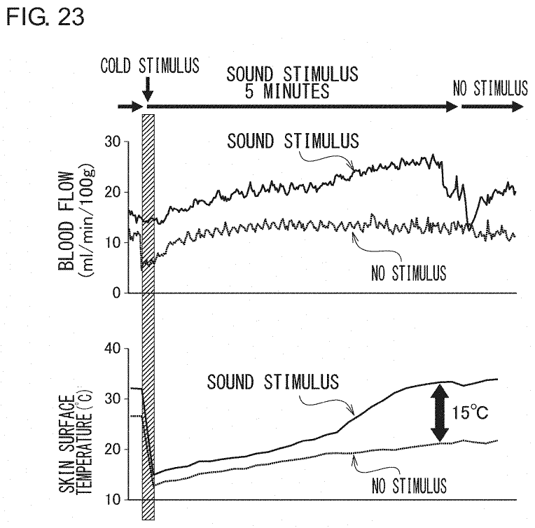

FIG. 23 shows the results of measuring the change in the blood flow and skin surface temperature of a human finger. A person put his finger in cold water (8 degrees Celsius) for one minute and the change in the blood flow and the change in the skin surface temperature in the presence or absence of a sound stimulus using a continuous sound were measured. In this observation, the sound stimulus started being applied while the finger was in the cold water.

As shown in the results of this experiment, by applying the sound stimulus while the finger was in the cold water, the blood flow rate of the finger in the cold water became higher and the surface temperature became higher compared to those in a case where no sound stimulus was applied. Further, after the finger was pulled up from the cold water, the degree of increased blood flow rate and the degree of increased surface temperature were higher in a case where the sound stimulus was applied. Based on these observations, it was confirmed that a sound stimulus was effective in improving excessive sensitivity to cold.

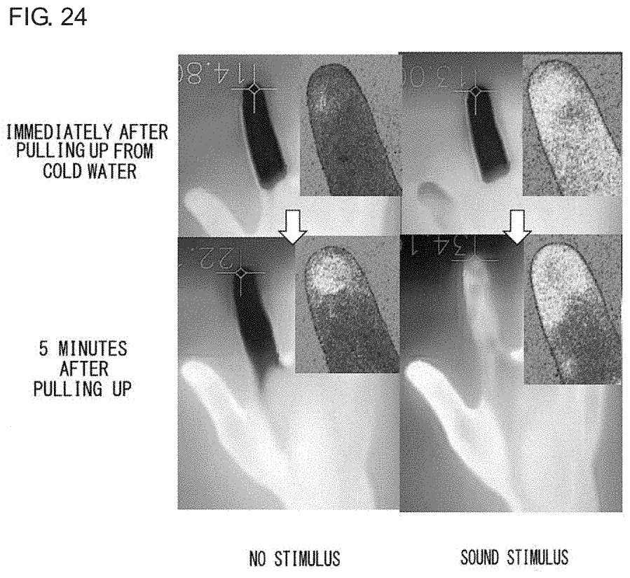

FIG. 24 shows images of the finger captured by a thermography camera. It can be seen from the images that the skin temperature rises in a short time by applying a sound stimulus.

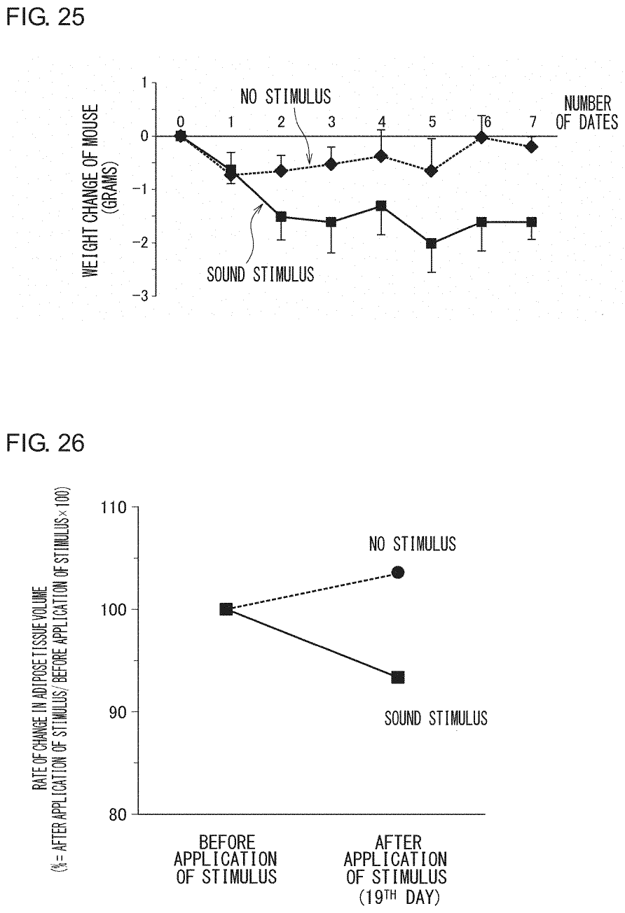

FIG. 25 shows the results of observing the effect of a sound stimulus on the body weights of mice. In this observation, obese mice induced on a high-fat diet were given a low-frequency intermittent sound of 70 Hz and 85 dB for five minutes a day, and their body weights were measured. The sound stimulus was a discontinuous sound in which an output period of 100 ms and a non-output period of 100 ms were alternately repeated. FIG. 26 shows the results of measuring the change in adipose tissue volume before and after (19 days later) the application of the sound stimulus by micro CT.

Based on the body weight change shown in FIG. 25, it is confirmed that the mice given the sound stimulus lost their body weight despite being fed a high-fat diet. Further, based on the results of the measurement of the change in the adipose tissue volume using the micro CT shown in FIG. 26, a decrease in the visceral fat of the mice on which the sound stimulus was applied was confirmed. These results indicate that a sound stimulus produce a weight-losing effect.

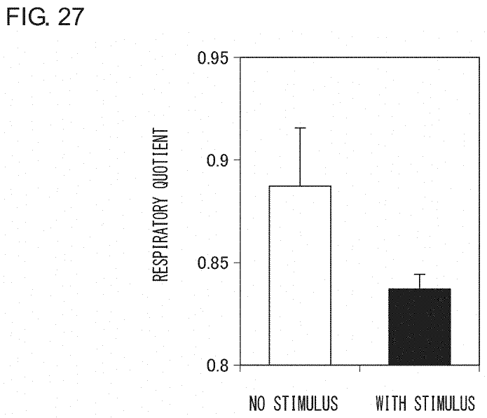

FIG. 27 shows the respiratory quotient of a mouse in the presence or absence of a sound stimulus. The respiratory quotient is a volume ratio of a carbon dioxide emission amount and an oxygen inhalation amount per unit time, which is 1.0 for carbohydrate metabolism and 0.7 for lipid metabolism. The graph on the left side of FIG. 27 shows the respiratory quotient of the mouse when no sound stimulus was applied, and the graph on the right side shows the respiratory quotient of the mouse after the sound stimulus was applied for five minutes. As shown in FIG. 27, it was observed that the conversion of carbohydrate metabolism to lipid metabolism was improved by applying the sound stimulus to the mouse. As a result of similar observations on the respiratory quotient of humans, it was found that the respiratory quotient of a person who received the sound stimulus decreased during and after the sound stimulus. This means that body fat was burned by the sound stimulus. It was therefore confirmed that sound stimuli were useful for cosmetic effects including weight loss and prevention or improvement of lifestyle-related diseases.

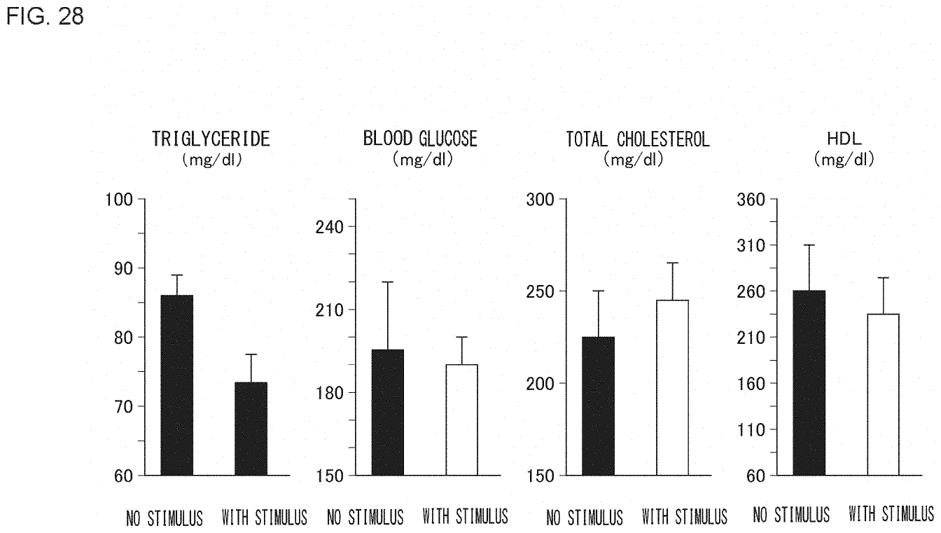

FIG. 28 shows measurement results of items related to lifestyle-related diseases. In this observation, six mice were continuously fed a high-fat diet for three weeks, and three mice were given a low frequency intermittent sound of 70 Hz and 85 dB for five minutes a day only for the last week. Three weeks after the high-fat diet was given (one week after the sound stimulus was applied), the triglyceride, blood glucose, total cholesterol, and HDL cholesterol of each mouse were measured. There was a great decrease in triglyceride in a group of mice given the sound stimulus for one week. From this result, it was also confirmed that the sound stimulus helped to reduce triglyceride.

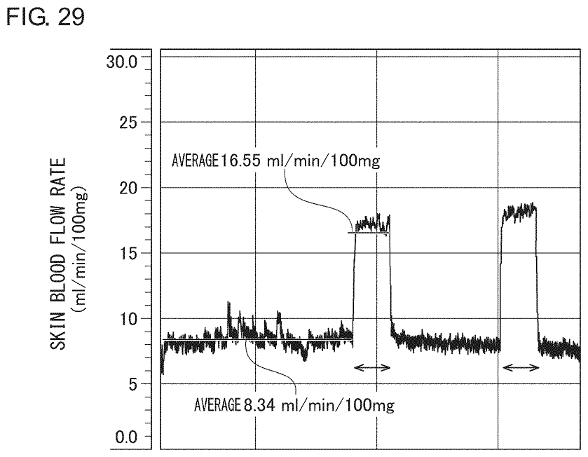

FIG. 29 shows the result of observing the effect of improving a pressure ulcer by a sound stimulus. In this experiment, pressure ulcers in mice were first induced by pinching skin with magnets. In this case, an induction method was adopted in which a blood flow probe was brought into close contact with the skin of a hind leg of a mouse and then sandwiched between magnets having an intensity of 1000 G from above and below to press the skin. FIG. 29 shows the change in the skin blood rate when a sound stimulus was applied when 15 minutes and 20 minutes had passed (the periods indicated by the double-headed arrows) after the start of the pressing under the ischemic environment (state in which the skin blood flow rate was decreased) of the hind leg.

In FIG. 29, an average skin blood flow rate of 8.34 ml/min/100 mg indicates a state where a pressure ulcer was induced, that is, a state of being ischemic. When an ischemic mouse was given an intermittent sound of 70 Hz and 85 dB, the skin blood flow rate increased to an average flow rate of 16.55 ml/min/100 mg. This average blood flow rate is substantially equal to the blood flow rate before the pressing of the skin. That is, it is confirmed that during a period in which the sound stimulus was applied to a mouse in an ischemic state, the ischemic state of the mouse was improved. This indicates that the sound stimulus according to the embodiments is effective in improving the symptoms of pressure ulcers.

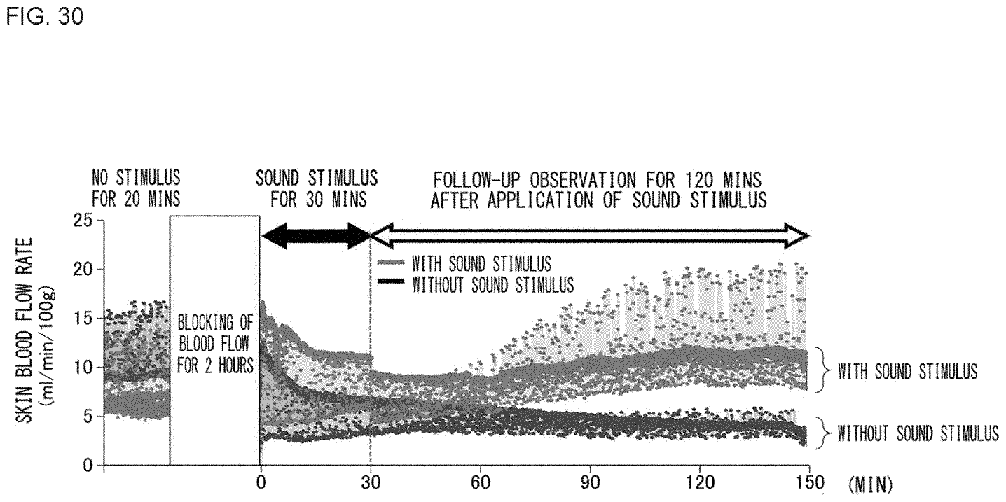

FIG. 30 shows the result of observing the effect of improving blood flow in a model mouse for pressure ulcer after a sound stimulus. In this observation, the skin on the back of two mice was first sandwiched between magnets and pressed for 2 hours to block the blood flow. Then, one mouse was given a sound stimulus for 30 minutes while another mouse was not given a sound stimulus. The skin blood flow rate of each mouse was measured using a two-dimensional laser blood flowmeter for 150 minutes. It was found as a result that the skin blood flow rate of the mouse to which the sound stimulus was not applied did not improve and the ischemic state was maintained. On the other hand, it was confirmed that the skin blood flow rate increased during the application of the sound stimulus in the mouse to which the sound stimulus was applied. It was confirmed that although the skin blood flow rate decreased immediately after the sound stimulus was stopped, the skin blood flow rate gradually increased thereafter. This indicates that the effect of applying the sound stimulus is sustained even after the sound stimulus is finished and it is effective in improving the symptoms of the pressure ulcer.

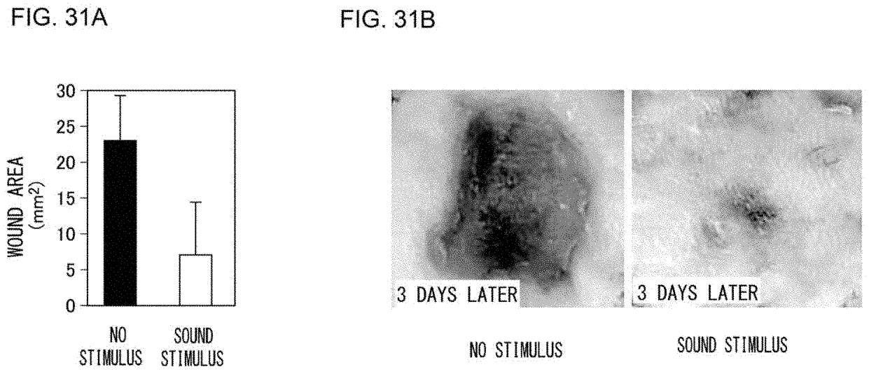

FIG. 31A shows the result of observing the effect of improving a pressure ulcer by a sound stimulus. In this observation, the skin on the back of six mice was sandwiched between magnets and pressed for two hours to induce pressure ulcers, then the sound stimulus was applied for thirty minutes to three mice while no sound stimulus was applied to the other three mice, and wound areas were then measured. This observation was performed daily, and the comparative result shown in FIG. 31A shows a wound area in each mouse group after six days. According to this comparison result, it was found that wound areas were greatly improved by applying the sound stimulus for thirty minutes after inducing the pressure sore state. FIG. 31B shows an image of the pressure ulcer state (after the application of the sound stimulus) captured three days later.

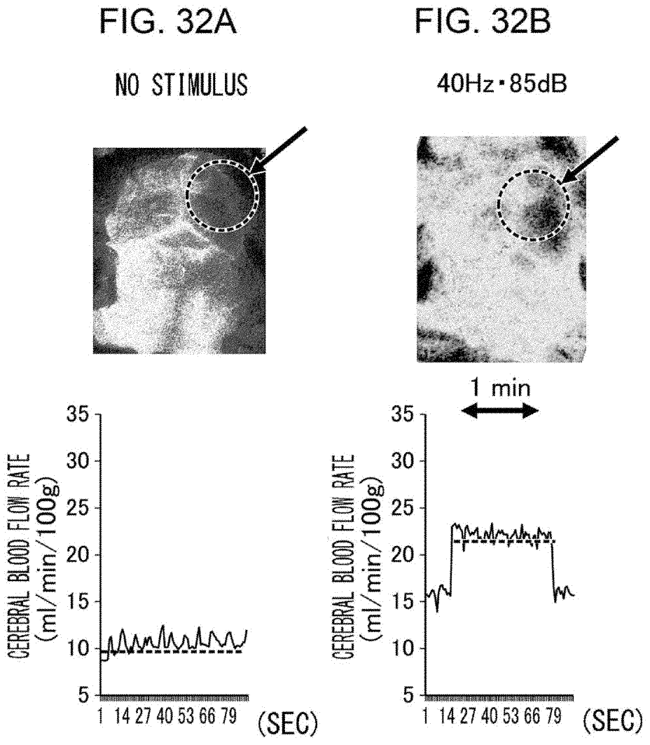

FIGS. 32A and 32B shows experimental results of measuring cerebral blood flow rate in a vascular dementia model mouse. In graphs shown in FIGS. 32A to 32B, the horizontal axis represents time (seconds), and the vertical axis represents cerebral blood volume (ml/min/100 g). In the images shown in FIGS. 32A to 32B, white areas indicate regions with high blood flow, dark areas indicate regions with low blood flow, and dotted circles indicate regions where blood flow was reduced by ligating cerebral arteries.

FIG. 32A shows the change in the cerebral blood flow rate when no sound stimulus was applied. When no sound stimulus was applied, the minimum level of the cerebral blood flow rate did not change. FIG. 32B shows the change in the cerebral blood flow rate when a sound stimulus of a continuous sound of a sound volume level of 85 dB and a frequency of 40 Hz was applied. The double-headed arrow indicates a period during which the sound stimulus was applied (one minute), and the cerebral blood flow rate increased during the application of the sound stimulus. Based on the results of this experiment, it is found that sound stimuli can possibly be used for prevention and improvement of vascular dementia.

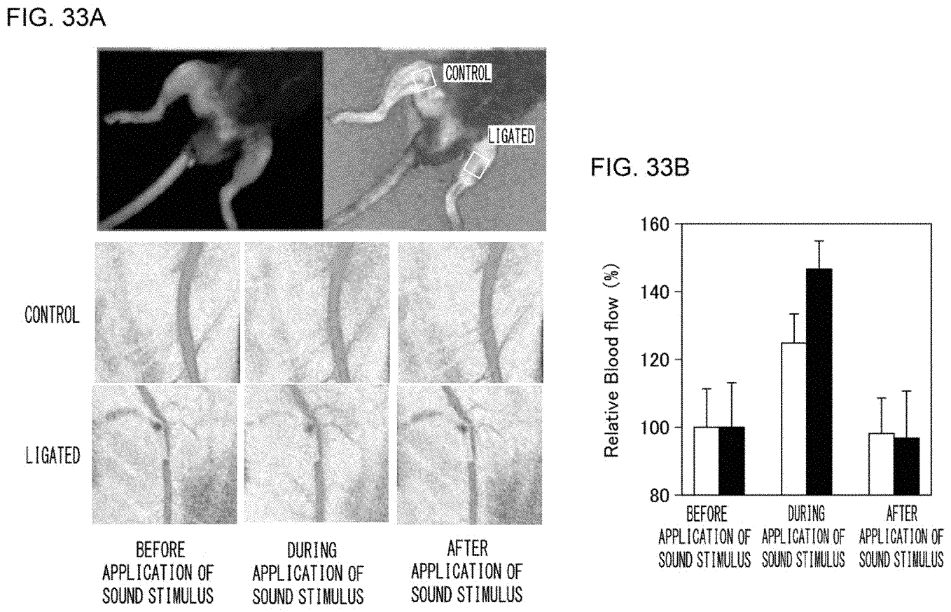

Next, one of the lower legs of a mouse was ligated, and the blood flow of the ligated lower leg and the blood flow of the unligated lower leg (control) were observed. FIG. 33A shows blood flow images of the two lower legs. In these blood flow images, black streaks represent arteries, and ligated blood flow images show that the blood vessel from the bottom to the top is thinned at a ligated site near the center. In the blood flow images of the ligated lower led, the vicinity of the ligated site became bright during the application of the sound stimulus, and this means that the blood flow of the capillaries near the ligated site increased. FIG. 33B shows the relative blood flow rates when the respective blood flows before the application of the sound stimulus are set to be 100%. White bar graphs show the blood flow rates of the control mouse, and black bar graphs show the blood flow rates of the ligated mouse. It was observed that the blood flow rate of the ligated mouse was greatly improved by applying the sound stimulus.

Based on the above observations, it is shown that the blood flow of an arterial thrombus model mouse is improved by applying the sound stimulus. This means, for example, the possibility of preventing necrosis (diabetic gangrene) caused due to limb blood flow failure due to diabetes.

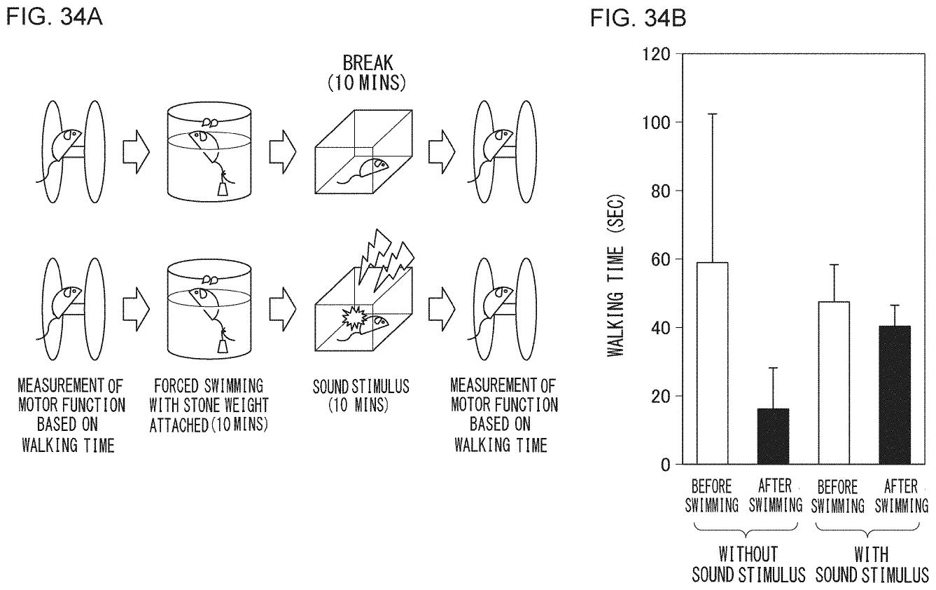

FIG. 34A shows the procedure of an observation experiment of fatigue recovery effects of a sound stimulus. In this observation experiment, the walking time of mice was first measured by a rotarod test, and then the mice were forced to swim in water for ten minutes with a weight attached. One mouse was then given a ten minute break, and the other mouse was given a ten minute sound stimulus. Then, the walking time was measured by a rotarod test again. FIG. 34B shows a comparison result of walking time before and after the swimming. It is shown that the walking time of the mouse that did not receive the sound stimulus was significantly shortened after the swimming. This means that the ten minute break did not cause the mouse to recover from fatigue. On the other hand, there was not much change before and after the swimming in the walking time of the mouse to which the sound stimulus was applied. This means that the ten minute sound stimulus caused the mouse to recover from fatigue. Based on these observation experiments, it is confirmed that a sound stimulus has a fatigue recovery effect.

By mounting the blood flow improvement device 1 on various vehicles including automobiles, buses, trains, trucks, ships, airplanes, rockets, and spacecraft and applying a sound stimulus of a sound volume level of 65 dB or more and a frequency of a value from 5 to 250 Hz to the user, effects of preventing or improving vascular obstructive diseases including economy class syndrome and gangrene of the arms and legs of diabetic patients can be expected through the promotion of blood flow. The setting unit 3 may set the sound volume level at the part to be stimulated to be in a predetermined range. The setting unit 3 may set the sound volume level to be in a range of, for example, 65 dB to 105 dB. The setting unit 3 may set the sound volume level to be low in a predetermined range when stimulating a part having a strong stimulus sensitivity and set the sound volume level o be high in a predetermined range when stimulating a part having a low stimulus sensitivity. By installing the blood flow improvement device 1 in a house, a factory, a living space of a space station, etc., at least any one of the improvement of symptoms including excessive sensitivity to cold, chloasma, pressure ulcers, or stiff shoulders, the recovery from fatigue, the prevention or improvement of lifestyle-related diseases, the prevention or improvement of vascular obstructive diseases, the prevention or improvement of dementia, or the beauty effects including weight loss can be expected. The blood flow improvement device 1 may be installed in various places as a mechanoreceptor activating device.

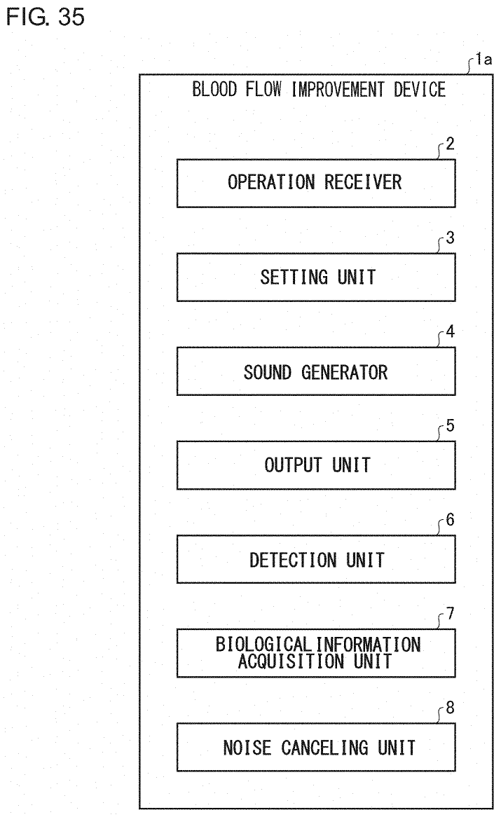

FIG. 35 shows an additional configuration of a blood flow improvement device 1a. The blood flow improvement device 1a includes a detection unit 6 for detecting a person or a specific part of a person, a biological information acquisition unit 7 for acquiring biological information of a person, and a noise canceling unit 8 in addition to the blood flow improvement device 1 shown in FIG. 1. The blood flow improvement device 1a may be an AI speaker installed in a room, a vehicle, or the like.

In the blood flow improvement device 1a, the setting unit 3 sets a sound stimulus having a sound volume level of 65 decibels or more and a frequency of a value from 5 to 250 hertz in order to improve blood flow, and the sound generator 4 generates the set sound stimulus. The output unit 5 has a speaker and outputs the sound stimulus generated by the sound generator 4 into the space. The setting unit 3 sets the sound volume level that is output from the speaker such that the sound volume level is 65 decibels or more at the position of the user whose blood flow is to be improved.

For example, the blood flow improvement device 1a may be installed at a predetermined distance from the user in a vehicle compartment. Further, it may be defined as a rule of use that the blood flow improvement device 1a is arranged at a predetermined distance from the user at the time of use. When the distance between the user and the blood flow improvement device 1a is fixed, the setting unit 3 sets the sound volume level to be 65 decibels or more at the user's position in consideration of the amount of attenuation due to the distance between the user and the blood flow improvement device 1a.

The detection unit 6 detects at least the presence or absence of a user in a space such as a room, a vehicle compartment, or the like. The detection unit 6 may detect the presence or absence of a user by acquiring an image of a camera that captures the inside of the space and analyzing the captured image. When the detection unit 6 detects the presence of a user, the detection unit 6 identifies the position of the user in the space and acquires the distance between the output unit 5 and the user.

The setting unit 3 may determine the sound volume level generated from the sound generator 4 and output from the output unit 5 according to the distance to the user. As a result, the setting unit 3 can calculate the mount of attenuation of the sound volume that corresponds to the distance and set the sound volume level to be 65 decibels or more at the user's position. The output unit 5 preferably has a directional speaker and outputs a sound stimulus toward the position of the user identified by the detection unit 6.

The detection unit 6 may have a function of detecting a specific part of the user. The detection unit 6 detects, for example, a part where a pressure ulcer is formed (or is likely to be formed) of a hospitalized patient who is lying on a bed. For example, the detection unit 6 may have a function of detecting the contact pressure between the bed and the patient's body and detect a part where a pressure ulcer is formed (is likely to be formed). When the patient is repositioned to prevent pressure ulcers, the output unit 5 having a directional speaker may output a sound stimulus to the part detected by the detection unit 6.

By providing the blood flow improvement device 1a on the bed in the hospital ward or the bed for home care, it is possible to realize a bed in which the output unit 5 can output a sound stimulus to the sleeping subject. As described above, the operation of the detection unit 6 and the output unit 5 allows a sound stimulus to be effectively applied to a specific part of the subject at this time.

Further, the blood flow improvement device 1a may be provided on the back side of a vehicle chair or the like. The outputting of a sound stimulus to the driver sitting on a chair by the output unit 5 of the blood flow improvement device 1a can improve the driver's recovery from fatigue and the like. The detection unit 6 may detect the driver's arms and legs in the vehicle compartment, and the output unit 5 may output a sound stimulus to the arms and legs.

The biological information acquisition unit 7 acquires the biological information of a subject to whom the sound stimulus is applied. For example, the biological information acquisition unit 7 may acquire the blood flow, heart rate, electrocardiogram, body temperature, fatigue level, etc., of the subject. Considering the burden on the subject, the biological information acquisition unit 7 can preferably acquire the biological information of the subject in a non-contact manner. For example, when it is detected from the biological information that the body temperature of the subject is getting low or the blood flow is out of the normal range, the setting unit 3 preferably sets the sound stimulus according to the acquired biological information. At this time, the lower the body temperature compared to the normal temperature, the longer the sound stimulus is preferably applied, and the higher the volume level is preferably raised. The setting unit 3 may monitor biological information during the application of the sound stimulus and stop the generation of the sound stimulus once sufficient improvement in body temperature and blood flow is observed.

The noise canceling unit 8 has a role of canceling noise in the space where the user exists. The noise canceling unit 8 detects noise generated in the space, generates a sound having a phase opposite to that of the noise, and cancels the noise. By canceling the noise, the effect of the sound stimulus output by the output unit 5 can be enhanced.

Described above is an explanation on the present disclosure based on the embodiment. This embodiment is intended to be illustrative only, and it will be obvious to those skilled in the art that various modifications to constituting elements and processes could be developed and that such modifications are also within the scope of the present disclosure. For example, since the blood flow improvement devices 1 and 1a generate sound, the blood flow improvement devices may be mounted on a thing that originally generates sound, for example, a home electric appliance such as a dryer and a refrigerator.

The outline of an aspect of the present disclosure is as follows. A blood flow improvement device according to one aspect of the present disclosure includes: a setting unit that sets a sound stimulus for improving blood flow; and a sound generator that generates the set sound stimulus, wherein the setting unit sets a sound stimulus of a sound volume level of 65 decibels or more and a frequency of a value from 5 to 250 hertz.

By applying a person a sound stimulus having a sound volume level of 65 decibels or more and a frequency of a value from 5 to 250 hertz, the blood flow of the person is improved.

The sound generator may generate a sound stimulus of a continuous sound. Further, the sound generator may generate a sound stimulus in an intermittent pattern in which an output period of the sound stimulus and a non-output period of the sound stimulus are alternately repeated. The setting unit may determine the sound volume level generated from the sound generator according to the distance to the subject. At this time, the setting unit preferably determines the sound volume level according to the distance to a spot of a subject to which the sound stimulus is to be applied, for example, an affected area at this time. The setting unit may set a sound stimulus for at least any one of the improvement of symptoms of excessive sensitivity to cold, chloasma, pressure ulcers, or stiff shoulders, the recovery from fatigue, the prevention or improvement of lifestyle-related diseases, the prevention or improvement of vascular obstructive diseases including economy class syndrome and gangrene of the arms and legs of diabetic patients, the prevention or improvement of dementia, or the improvement of beauty effects including weight loss.

The blood flow improvement device may include a biological information acquisition unit that acquires biological information of a subject, and the setting unit may set a sound stimulus according to the acquired biological information. The blood flow improvement device may include an output unit that outputs a sound stimulus generated by the sound generator. The blood flow improvement device may include a detection unit that detects a specific part of the subject, and the output unit may output a sound stimulus to the part detected by the detection unit. The blood flow improvement device may be mounted on a chair or bed and output a sound stimulus to the subject.

A blood flow improvement device according to another aspect of the present disclosure includes: a setting unit that sets a sound stimulus for activating a mechanoreceptor; and a sound generator that generates the set sound stimulus, wherein the setting unit sets a sound stimulus of a sound volume level of 65 decibels or more and a frequency of a value from 5 to 250 hertz.

By applying a person a sound stimulus having a sound volume level of 65 decibels or more and a frequency of a value from 5 to 250 hertz, mechanoreceptors such as an ion channel piezo 1 can be activated.

A program according to another aspect of the present disclosure is a program comprising computer-implemented modules including: a module that sets a sound stimulus having a sound volume level of 65 decibels or more and a frequency of a value from 5 to 250 hertz; and a module that generates the set sound stimulus.

By applying a person a sound stimulus having a sound volume level of 65 decibels or more and a frequency of a value from 5 to 250 hertz, the blood flow of the person is improved.

The module that generates sound may include a module that superimposes a sound stimulus on another sound.

### INDUSTRIAL APPLICABILITY

The present disclosure relates to a technology for utilizing sound stimuli.

### REFERENCE SIGNS LIST

1, 1a blood flow improvement device, 2 operation receiver, 3 setting unit, 4 sound generator, 5 outputting unit, 6 detection unit, 7 biological information acquisition unit, 8 noise canceling unit

1. A blood flow improvement device comprising:
a setting unit that sets a sound stimulus for improving a blood flow;
a sound generator that generates the set sound stimulus; and
an output unit that outputs the sound stimulus generated by the sound generator from a position away from a subject, wherein
the setting unit sets the sound stimulus such that the output sound stimulus has a sound volume level of 65 decibels or more and a frequency of a value from 5 to 250 hertz when the output sound stimulus reaches the subject.

2. The blood flow improvement device according to claim 1, wherein
the sound generator generates a sound stimulus of a continuous sound.

3. The blood flow improvement device according to claim 1, wherein
the sound generator generates a sound stimulus in an intermittent pattern in which an output period of the sound stimulus and a non-output period of the sound stimulus are alternately repeated.

4. The blood flow improvement device according to claim 1, wherein
the setting unit determines the sound volume level that is output from the output unit according to the distance to the subject.

5. The blood flow improvement device according to claim 1, wherein
the setting unit sets a sound stimulus for at least any one of the improvement of symptoms of excessive sensitivity to cold, chloasma, pressure ulcers, or stiff shoulders, the recovery from fatigue, the prevention or improvement of lifestyle-related diseases, the prevention or improvement of vascular obstructive diseases, the prevention or improvement of dementia, or the improvement of beauty effects including weight loss.

6. The blood flow improvement device according to claim 1, comprising:
a biological information acquisition unit that acquires biological information of the subject, wherein
the setting unit sets a sound stimulus according to the acquired biological information.

7. The blood flow improvement device according to claim 1, comprising:
a detection unit that detects a specific part of the subject, wherein
the output unit outputs a sound stimulus to the part detected by the detection unit.

8. A chair comprising the blood flow improvement device according to claim 1, wherein the output unit outputs a sound stimulus to the subject sitting on the chair.

9. A bed comprising the blood flow improvement device according to claim 1, wherein the output unit outputs a sound stimulus to the subject whose body is in contact with the bed.

10. A blood flow improvement device comprising:
a setting unit that sets a sound stimulus for activating a mechanoreceptor;
a sound generator that generates the set sound stimulus; and
an output unit that outputs the sound stimulus generated by the sound generator from a position away from a subject, wherein
the setting unit sets the sound stimulus such that the output sound stimulus has a sound volume level of 65 decibels or more and a frequency of a value from 5 to 250 hertz when the output sound stimulus reaches the subject.

11. A recording medium having embodied thereon a program comprising computer-implemented modules including:
a module that sets a sound stimulus having a sound volume level of 65 decibels or more and a frequency of a value from 5 to 250 hertz at a position of a subject;
a module that generates the set sound stimulus; and
a module that outputs the generated sound stimulus from a position away from the position of the subject.

12. The recording medium according to claim 11, wherein
the module that generates sound includes a module that superimposes a sound stimulus on another sound.

13. A blood flow improvement device comprising:
a setting unit that sets a sound stimulus for improving a blood flow;
a sound generator that generates the set sound stimulus; and
an output unit that outputs the sound stimulus generated by the sound generator from a position away from a subject, wherein
the setting unit sets a sound stimulus of a pure tone such that the output sound stimulus has a sound volume level of 65 decibels or more and a frequency of a value from 20 to 150 hertz when the output sound stimulus reaches the subject.
